(19) United States
(12) Patent Application Publication
(10) Pub. No.: US 2020/0045424 A1
(43) Pub. Date: Feb. 6, 2020

(54) MULTI-CHAMBERED PORTED RESONATOR FOR DISTRIBUTED MODE AND BALANCED MODE RADIATOR TRANSDUCERS

(71) Applicant: Rembrandt Laboratories, LLC, Irvine, CA (US)

(72) Inventor: Raymond W. Imblum, Corona, CA (US)

(21) Appl. No.: 16/236,184

(22) Filed: Dec. 28, 2018

Related U.S. Application Data
(60) Provisional application No. 62/714,955, filed on Aug. 6, 2018.

(51) Int. Cl. H04R 7/04; H04R 1/02

(52) U.S. Cl. CPC H04R 7/045; H04R 2440/07; H04R 1/025

(57) ABSTRACT

A resonator comprising an outer wooden cabinet with a distributed mode transducer mounted in an outer front face of the cabinet, a reflex port disposed in the outer front face of the cabinet, and a resonator plate disposed within the cabinet, thereby forming a ported resonance chamber between the cabinet front face and the resonator plate and a sealed chamber between the resonator plate and a rear face of the cabinet.

### CROSS-REFERENCE TO RELATED APPLICATIONS

This application relates to and claims the benefit of U.S. Provisional Application No. 62/714,955, filed Aug. 6, 2018 and entitled MULTI-CHAMBERED PORTED RESONATOR FOR DISTRIBUTED MODE AND BALANCED MODE RADIATOR TRANSDUCERS

### STATEMENT RE: FEDERALLY SPONSORED RESEARCH/DEVELOPMENT

Not Applicable

### BACKGROUND

The present disclosure relates generally to an improved speaker unit, and more particularly to a speaker unit comprising a distributed mode planar transducer or a balanced mode radiator transducer mounted in a multi-chambered ported cavity wherein one wall of the cavity comprises a tuned resonating laminated plate that also forms a completely sealed cavity.

In general, most speakers utilize one or more pistonic cone speakers to create sound. By doing so, it sounds like the sound is coming directly from the speaker box. Traditional speakers (pistonic point source devices) create a hemispherical field radiated from a point source. This has the potential to create echo artifacts that are unnatural to the human ear. In contrast, to a blind-folded person, a good speaker should be indistinguishable from a real piano in the room, a real violin in the room, or a real singer in person in the room. As such, there is a need for a better basic sound generating technology than pistonic point sources. In particular, there is a need for a speaker unit that reinforces that device's coupling to the air to reproduce the same type of sound field as the instrument or human voice does in nature. There is a need for a resonance chamber system with fine tuning characteristics without the use of the traditional techniques that have the side effect of causing muffled and muddy sound reproduction.

In order to overcome these problems, one can use a distributed mode transducer in place of, or in addition to, a traditional pistonic speaker. Distributed mode transducers are a newer technology that work fundamentally differently than traditional pistonic cone speakers (which are the traditional “point source” devices that move air through a forward and back piston-like motion). Distributed mode transducers instead stimulate a very sophisticated laminated and strategically weighted disk through “bending wave” energy. Bending waves would normally create a primary “mode” in a monolithic plate. However the disk/plate in the “distributed mode” transducer is weighted at the fundamental node in order to prevent fundamental response and instead “distribute” the primary mode to secondary responses. In like manner the secondary responses are “distributed” until the disk has an even response across a wide frequency spectrum. Sonic energy is then coupled into the air through the coupling to the small “transverse wavelets” covering the entire surface of the disk. This results in a transducer that has much wider bandwidth (200 Hz to 20 kHz) than a pistonic speaker, does not beam at higher frequencies, and creates a coherent wave pattern from the face of the disk instead of a point source hemispheric pattern.

However, until recently, the technology was not mature enough to produce a transducer without artifact issues. There are now transducers capable of creating a coherent field, not a point source field, with even power output from 200 hertz to 20 kilohertz in a single transducer. On their own, these distributed mode transducers, even though producing better, sound than a pistonic speaker, still do not attain a satisfactory level of realism.

As such, there is a need for a speaker unit capable of producing a significantly high level of realism, detail, and extremely faithful reproduction of strings, piano, violins, horns, drums and vocals without distortion or muffling.

### BRIEF SUMMARY

The present disclosure contemplates a resonator made up of an outer wooden cabinet, having a bottom face, a top face, a front face, a rear face, and two side faces to create an inner cavity. The resonator further includes a distributed mode transducer mounted in the front face and a reflex port disposed in the front face. Additionally, the resonator includes a resonator plate disposed in the inner cavity. The resonator plate is in sealed contact with the inside of at least four of the cabinet faces, thereby creating a ported resonance chamber between the cabinet front face and the resonator plate and a sealed chamber between the resonator plate and the cabinet rear face.

The cabinet faces may be angled in relation to each other so that none of the faces are parallel to another face. Additionally, the resonator plate may be disposed at an angle in relation to the cabinet front face.

The resonator may further include a pistonic speaker mounted in the front face. In this embodiment, the cabinet further includes at least one internal dividing face set inside the cabinet below the pistonic speaker to form a pistonic speaker cavity. The resonator may further feature a second reflex port disposed in an outer face of the pistonic speaker cavity.

The resonator may also feature an amplifier disposed within the cabinet inner cavity. The amplifier is in electrical connection with the distributed mode transducer, and the pistonic speaker if present. This embodiment may have at least one internal dividing face set inside the cabinet to form an amplifier cavity in which the amplifier is disposed.

Another embodiment of the present disclosure contemplates a resonator made up of an outer wooden cabinet having a bottom face, a top face, a front face, a rear face, and two side faces to create an inner cavity. The inner cavity further includes internal dividing faces disposed within to form a first resonance chamber, a second resonance chamber, and a component chamber. The resonator has a distributed mode transducer mounted in the front face of the first resonance chamber and also a first reflex port disposed in the front face of the first resonance chamber. Additionally, the resonator includes a resonator plate disposed in the first resonance chamber. The resonator plate is in sealed contact with the inside of first resonance chamber, thereby creating a ported first resonance chamber in front of the resonator plate and a sealed first resonance chamber behind the resonator plate.

This embodiment further includes a pistonic speaker mounted in the front face of the second resonance chamber and a second reflex port disposed in an outer face of the second resonance chamber. Further included in the resonator is an amplifier disposed within the component chamber. The amplifier is in electrical connection with both the distributed mode transducer and the pistonic speaker.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of a multi-chambered ported resonator of the present disclosure;

FIG. 2 is a side cutout view of the resonator shown in FIG. 1;

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring to the Figures, one particularly unique aspect of the resonator 10 of present disclosure is the use of a resonator plate 12, acoustically loaded by a sealed chamber 14, tuned to be sympathetic to the bipolar back energy of a distributed mode transducer 16 mounted inside a ported resonance chamber 18. This allows for the production of a coherent field that is emitted in-phase with the front face of the transducer 16 through a reflex port 20, thereby providing a realistic field in front of the transducer 16 face. The resonator 10 relies upon the interaction of the sealed chamber 14, the resonator plate 12, the ported chamber 18, the geometry of both chambers to avoid standing waves, and the F-slot reflex port 20 that provides field emissions and chamber damping through air velocity restriction. As is shown in the figures, the resonator plate 12 forms one wall of the sealed chamber 14 as well as one wall of the ported chamber 18. Accordingly, the acoustic field inside the ported chamber 18 is stimulated by both the back of the transducer 16 and the front of the resonator plate 12.

The ported chamber 18 is basically a Helmholtz ported chamber with one important difference: the rear wall of the chamber 18 is a secondary radiator 12 that is rigid enough to keep the basic tuning of the Helmholtz, but has adjustable Q and roll off. In certain embodiments, the resonator plate 12 is a lamination of foam and paper, with an impedance matched to the air as well as the laminated disc of the distributed mode transducer 16. The volume of trapped air in the sealed chamber 14 behind the resonator plate 12 affects the Q of the resonator plate 12 similarly to the 0.707, 0.80. and 0.90 operating points of a closed box system. The lamination of dissimilar materials in the resonator plate 12 allows for the control of the native Q of the resonator plate 12 through constrained layer damping. Furthermore, the geometry of the resonator plate 12 may be varied to further tune the entire resonator 10.

With the resonator 10 disclosed herein, the transducer 16 generates the primary acoustic energy. The resonator plate 12 is sympathetically energized by the bipolar back energy of the transducer 16 in the ported resonance chamber 18. The sealed chamber 14 behind the resonator plate 12 is part of the Q factor of the plate 12. The transducer 16 and the resonator plate 12 both stimulate the ported resonance chamber 18, while the resonator plate 12 affects tuning. The acoustic field inside the ported resonance chamber 18 escapes through the front reflex port 20, which is closely coupled to the front radiation of the transducer 16.

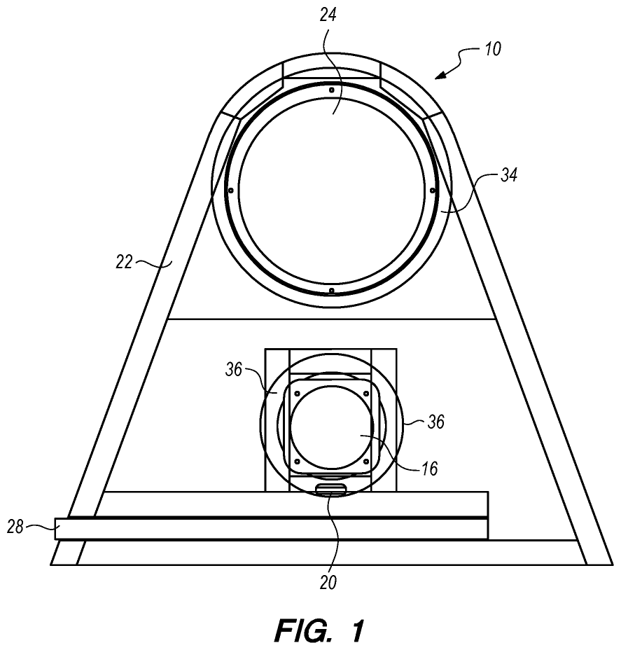

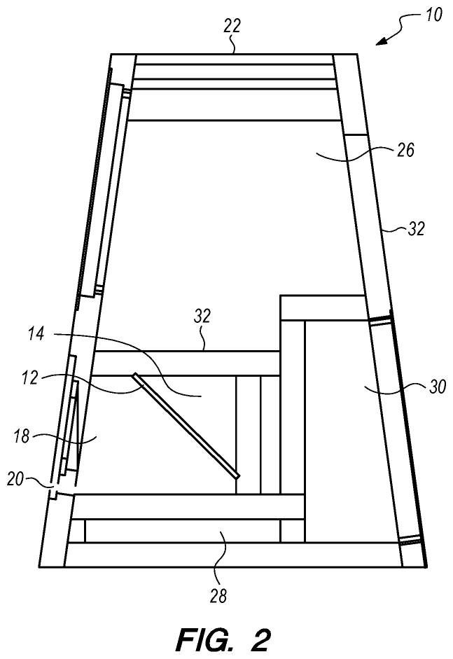

FIGS. 1 and 2 show one preferred embodiment of the resonator 10 of the present disclosure. In that regard, the resonator 10 is comprised of a cabinet 22 that houses a distributed mode transducer 16, with the two chambers 14, 18 divided by a resonator plate 12, as described above. This embodiment, however, further comprises a traditional pistonic speaker 24 mounted in a pistonic speaker cavity 26. This pistonic speaker cavity 26 has its own pistonic speaker reflex port 28. This embodiment, further comprises a separate amplifier cavity 30 that contains an amplifier (not shown) and other electronic components (not shown). In particular, the ported distributed mode resonance chamber 18, distributed mode sealed chamber 14, pistonic speaker cavity 26, and amplifier cavity 30 are all sealed airtight relative to each other inside the cabinet 22.

In this preferred embodiment, the cabinet 22 is built from tulip poplar wood commonly used to build violins and cellos. Furthermore, the cabinet 22 may be built such that certain wood pieces are assembled “cross grain” from each other to help dampen cabinet resonances. The resonator 10 may be combined with an acoustic isolation pad (not shown) as a separate part that the cabinet 22 rests upon. This allows the cabinet 22 to be placed upon all types of flat surfaces while the acoustic isolation pad decouples the vibration in the cabinet 22 from the surface the cabinet 22 is resting upon. This prevents unwanted excitation of the table surface by the cabinet 22 and allows the bottom surface of the cabinet 22 to freely respond as a wall of the pistonic speaker reflex port 28.

In one embodiment the pistonic speaker 24 is a 6.5 inch cone speaker. In this embodiment, the pistonic speaker cavity 26 has no parallel sides so as to avoid the standing waves prevalent in traditional speaker enclosures with parallel sides. In this embodiment, the pistonic speaker cavity 26 is shaped like a pyramid; however, other shapes that avoid parallel sides may be used, for example, a pentagon with five sides that do not directly face each other.

In certain embodiments, the pistonic speaker 24 may be mounted to the cabinet 22 by bonding a metal ring 34 to an opening in the cabinet 22 with a compound composed of a very thick acoustically damped adhesive such that the inner surface of the ring 34 is in contact with a front gasket (not shown) of the speaker 24.

Furthermore, in this embodiment, the walls of the pistonic speaker cavity 26 are flat plates 32. These plates 32 are not square or rectangular, but are tapered so that they do not reflect vibrational energy back from their edges symmetrically. By being shaped in such a fashion, the resonator 10 avoids a fundamental response that would color the music. As was discussed above, different configurations could be used, for example, in a pentagon shape configuration, alternating up tapered and down tapered walls could accomplish this same goal of avoiding coloring the music.

In this embodiment, the pistonic speaker cavity 26 further includes a thin, but wide and long throated reflex port 28. In one example, the pistonic reflex port 28 is six inches wide and 12.2 inches long, but only 0.72 inches tall. By utilizing such a geometry, the port 28 minimizes turbulent airflow and promotes laminar flow in the port throat.

The distributed mode planar transducer 16, also known as a balanced mode radiator, is mounted in a multi-chambered cavity, the front of which is a ported resonance chamber 18. In this particular embodiment, the transducer 16 is buffered from the wood surface of the cabinet 22 on both sides with rubber gaskets (not shown) and overlaid with a metal ring 36 filled and bonded to the cabinet 22 with a thick acoustically damped adhesive.

The ported resonance chamber shares a wall 12 with the distributed mode sealed chamber 14. The wall is a tuned resonating laminated plate 12 that is configured to enhance the bipolar back energy of the transducer 16 and introduce it through a front port 20 at the face of the transducer 16 and closely coupled to the transducer 16. This multi-chambered cavity is comprised of both the ported resonance chamber 18 and the sealed chamber 14, and further utilizes methods of fine tuning the response of the resonator plate 12 that separates the two chambers 14, 18, along with the overall geometric construction, and damping to create a resonator 10 with no parallel in the prior art.

In that regard, the bipolar back energy of the distributed mode transducer 16 stimulates the resonator plate 12, causing the plate 12 to become an intentional secondary radiator, thereby creating two sources of acoustic energy inside the resonance chamber 18. The resonator plate 12 further modifies the transfer function of the ported resonance chamber 18. The front facing reflex port 20 is dimensioned to affect both the damping of the chamber 18 by creating back pressure due to the air velocity through the port 20 and the low end response of the chamber 18 by using “F slot” calculations similar to those used in musical instruments. Furthermore, the port 20 acts as a closely coupled acoustic radiator of the energy within the chamber 18. The port 20 is closely coupled to the acoustic energy off the face of the transducer 16 even at high frequencies due to its proximity to the face of the transducer 16.

The resonator plate 12 can be tuned as desired by changing multiple variables, including the material, thickness, area, and geometry of the plate 12 itself, as well as the volume of the sealed chamber 14. Furthermore, the resonator plate 12 can be tilted to avoid standing wave distortion that would be created from parallel active surfaces in the ported resonance chamber 18 and the sealed chamber 14.

The resonator 10 further includes the necessary electronics to drive the speakers. These electronics are housed in a separate amplifier cavity 30. The amplifier cavity 30 is sealed airtight relative to the pistonic speaker cavity 26, the ported distributed mode resonance chamber 18, and the distributed mode sealed chamber 14. In one particular embodiment, the amplifier cavity 30 encloses a 300 watt amplifier (not shown) set to an operating point to match the impedance of the speaker 24 and transducer 16. The amplifier is designed to be able to maintain the 0.1% THD operating point of the amplifier when the pistonic speaker 24 is operating at its full RMS wattage rating.

The amplifier cavity 30 can also house the other necessary electronics such as a power control module (not shown) that switches external DC power to the amplifier, an audio network module (not shown) that provides audio connections to a rear panel, an audio circuit for 3.5 mm stereo to couple the right and left channel stereo signals into a single mono audio signal, as well as two separate RCA connectors for right and left stereo signals. The cavity 30 can further include a 10,000 microfarad capacitor capable of providing at least 8 amperes of ripple current to the amplifier.

By mounting the amplifier directly in the cabinet 22, one is able to prevent signal degradation by using very short cables from the amplifier to the speaker 24 and transducer 16. Additionally, having an integrated amplifier allows for ease of setup and ease of use, as no external amplifier is necessary. Furthermore, the user is capable of achieving a “plug and play” user experience by merely plugging the AC cord in to a power receptacle, the DC cord to the resonator 10, and their audio source to the resonator 10 before being able to listen to music.

Additional components that can be present in the amplifier cavity 30 include crossover network components, audio digital signal processors, multi-band equalizers, WiFi modules, Bluetooth modules, a HiFi RFI audio receiver, a room equalization computer, and other devices used in the audio electronics industry.

In this embodiment, the power supply (not shown) is external to the cabinet 22. The power supply is self contained and attaches to the resonator 10 via a DC cable and to a standard AC wall receptacle with an AC cable.

The above description is given by way of example, and not limitation. Given the above disclosure, one skilled in the art could devise variations that are within the scope and spirit of the invention disclosed herein, including various shapes of the cabinet and location and configuration of the cavities and components. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A resonator comprising:
an outer wooden cabinet comprising a bottom face, a top face, a front face, a rear face, and two side faces to create an inner cavity;
a distributed mode transducer mounted in the front face;
a reflex port disposed in the front face;
a resonator plate disposed in the inner cavity, wherein the resonator plate is in sealed contact with the inside of at least four of the cabinet faces, thereby creating a ported resonance chamber between the cabinet front face and the resonator plate and a sealed chamber between the resonator plate and the cabinet rear face.

2. The resonator of claim 1, wherein the cabinet faces are angled in relation to each other so that none of the faces are parallel to another face.

3. The resonator of claim 1, wherein the resonator plate is disposed at an angle in relation to the cabinet front face.

4. The resonator of claim 1 further comprising a pistonic speaker mounted in the front face, wherein the cabinet further comprises at least one internal dividing face set inside the cabinet below the pistonic speaker to form a pistonic speaker cavity.

5. The resonator of claim 4 further comprising a second reflex port disposed in an outer face of the pistonic speaker cavity.

6. The resonator of claim 1 further comprising an amplifier disposed within the cabinet inner cavity, the amplifier in electrical connection to the distributed mode transducer.

7. The resonator of claim 6 further comprising at least one internal dividing face set inside the cabinet to form an amplifier cavity in which the amplifier is disposed.

8. A resonator comprising:
an outer wooden cabinet comprising a bottom face, a top face, a front face, a rear face, and two side faces to create an inner cavity;
the inner cavity further comprising internal dividing faces disposed to form a first resonance chamber, a second resonance chamber, and a component chamber;
a distributed mode transducer mounted in the front face of the first resonance chamber;
a first reflex port disposed in the front face of the first resonance chamber;
a resonator plate disposed in the first resonance chamber, wherein the resonator plate is in sealed contact with the inside of first resonance chamber, thereby creating a ported first resonance chamber in front of the resonator plate and a sealed first resonance chamber behind the resonator plate;
a pistonic speaker mounted in the front face of the second resonance chamber;
a second reflex port disposed in an outer face of the second resonance chamber; and
an amplifier disposed within the component chamber, the amplifier in electrical connection with the distributed mode transducer and the pistonic speaker.
